(19) United States
(12) Patent Application Publication
(10) Pub. No.: US 2025/0287974 A1
(43) Pub. Date: Sep. 18, 2025

(54) TREATED VEGETABLE PROTEIN PRODUCT AND METHOD OF MAKING THE SAME

(71) Applicant: Cargill, Incorporated, Wayzata, MN (US)

(72) Inventors: Yara Licceth BENAVIDES PAZ, Plymouth, MN (US); Alexandra Jean FIEGEL, Albertville, MN (US); Chathurada Sugeeshvarie GAJADEERA, Plymouth, MN (US); Daniel Scott GASPARD, Victoria, MN (US); Mohammad Sharif KHAN, Rogers, MN (US); Erika Lyn MCCONVILLE, Golden Valley, MN (US); Michael Alan MORTENSON, Rogers, MN (US); Michael Arthur PORTER, Maple Grove, MN (US)

(73) Assignee: Cargill, Incorporated, Wayzata, MN (US)

(21) Appl. No.: 18/862,370

(22) PCT Filed: May 8, 2023
(86) PCT No.: PCT/US2023/021395

§ 371 Date: Nov. 1, 2024

Related U.S. Application Data
(60) Provisional application No. 63/364,280, filed on May 6, 2022.

(51) Int. Cl. A23J 3/26; A23J 3/16; A23J 3/18; A23L 5/20

(52) U.S. Cl. CPC A23J 3/26; A23J 3/16; A23J 3/18; A23L 5/27

(57) ABSTRACT

The disclosure relates to a treated vegetable protein product and a method of making the same. The method comprises providing an extruded vegetable protein material and performing a washing step on the extruded vegetable protein material to generate the treated vegetable protein product. The treated vegetable protein product has one or more improved attributes compared to the extruded vegetable protein material. Further, the disclosure relates to a method of washing an extruded vegetable protein material to obtain a treated vegetable protein product.

### CROSS-REFERENCE TO RELATED APPLICATIONS

This application claims the benefit of U.S. Provisional Patent Application No. 63/364,280, filed May 6, 2022, which is hereby incorporated by reference in its entirety.

### BACKGROUND

Extruded vegetable protein products have long been used for extending processed meat products and as bases for meat analogs. A conventional way to make extruded vegetable protein products, such as extruded soy protein concentrate, involves extracting untoasted defatted soy flakes with 70 wt % ethanol: 30 wt % water to remove the soluble sugars without dissolving the protein. The resulting product is desolventized and milled to become the soy protein concentrate products. The product can then be extruded into forms useful in extending meat products.

In meat analogs, the issue of protein concentration is important and there is a demand to have meat analogs with higher protein concentration by a more simplified manufacturing process. Thus, a treated vegetable protein product having a higher protein content and an improved method for making such product is needed.

### SUMMARY

The present disclosure provides a method of making a treated vegetable protein product comprising the steps of providing an extruded vegetable protein material, and performing a washing step on the extruded vegetable protein material to obtain the treated vegetable protein product. The washing step comprises washing the extruded vegetable protein material at a washing temperature of room temperature to 85° C. with a washing agent. The ratio of the washing agent to the extruded vegetable protein material used in the washing step is 4:1 to 40:1. The treated vegetable protein product has one or more improved attributes compared to the extruded vegetable protein material. Also described herein is the treated vegetable protein product produced by the above method.

The present disclosure also provides a method of washing an extruded vegetable protein material comprising the steps of washing the extruded vegetable protein material at a washing temperature of from room temperature to 85° C. with a washing agent in a ratio of, washing agent to extruded vegetable protein material, from 4:1 to 40:1 to obtain a washed material; and drying the washed material at a drying temperature of 75° C. to 120° C. to obtain a treated vegetable protein product. The treated vegetable protein product has one or more improved attributes compared to the extruded vegetable protein material.

The present disclosure also provides a treated vegetable protein product having one or more improved attributes compared to an unwashed extruded vegetable protein material. The one or more improved attributes are selected from the group consisting of an increased protein content, a reduced metal ion content, and any combinations thereof.

### DETAILED DESCRIPTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Unless defined otherwise, all technical and scientific terms used herein have the same meaning as commonly understood by one skilled in the art to which this invention belongs. As used herein, each of the following terms has the meaning associated with it as defined below.

Unless expressly stated, ppm (parts per million), percentage, and ratios are based on a dry weight basis. Percentage based on a dry weight basis is also referred to as wt % below.

The term “for example,” “for instance,” “such as,” or “including” as used herein is meant to introduce examples that further clarify more general subject matter. Unless otherwise specified, these examples are provided only as an aid for understanding the applications illustrated in the present disclosure and are not meant to be limiting in any fashion.

As used herein, the term “extruded” refers to a description for a material that has undergone an extrusion process. For example, an “extruded material” refers to a material that has passed through an extruder (using single or twin-screw configurations), together with sufficient water to create an “extruded product”. Historically, some extruded protein ingredients have been called textured vegetable protein, textured vegetable protein, or various other names indicating a protein type after extrusion.

During the most common type of protein extrusion, a hydrated protein ingredient is heated while shearing such that an extruded mass reaches above the boiling point of water. The extruded mass passes through an orifice such that there is a sudden change in pressure and the water boils creating steam. The steam expands the structure resulting in an extruded structure. Regulation of the pressure drop, temperature, moisture, and feed rate allow one skilled in the art to create different sizes, shapes, and textures of extruded products. The extruded product can be dried in a variety of conventional dryers or used without drying in the invention described here.

As used herein, “room temperature” or “RT” refers to a temperature between 20° C. to 25° C.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

Described herein is a treated vegetable protein product and a method of making the treated vegetable protein product. The treated vegetable protein product is suitable for use as a protein source for incorporation into foods for human and/or animal consumption.

### Method of Making Treated Vegetable Protein Product

A method of making a treated vegetable protein product described in the present disclosure comprises the steps of: (a) providing an extruded vegetable protein material, and (b) performing a washing step on the extruded vegetable protein material at a washing temperature of room temperature to 85° C. with a washing agent to obtain the treated vegetable protein product. The washing agent to the extruded vegetable protein material used in the washing step is in a ratio of 4:1 to 40:1. The resulting treated vegetable protein product has one or more improved attributes compared to the extruded vegetable protein material.

Preferably, the one or more improved attributes may include, but may not be limited to, an increased protein content, a reduced metal ion content, or any combinations thereof.

Extruded vegetable protein material serves as the starting material being fed to the washing step. Examples of extruded vegetable protein material may include extruded soy concentrate, extruded pea protein, and extruded wheat protein. Preferably, the extruded wheat protein may include a blend of vital wheat gluten, soy flour, and one or more processing aids typically used in the industry. For example, the extruded wheat protein may include vital wheat gluten in a range of from 70 to 85 wt %, from 75 to 82 wt %, or from 78 to 80 wt % on a dry basis, and soy flour in a range of from 10 to 25 wt %, from 15 to 22 wt %, or from 17 to 20 wt % based on a dry basis.

Preferably, the extruded vegetable protein material is not extruded soy flour.

The extruded vegetable protein material can have a protein content (initial protein content) in a range of from 45 to 80 wt %, from 50 to 75 wt %, 55 to 70 wt %, or 60 to 65 wt % on a dry basis.

The treated vegetable protein product can have a protein content in a range of 55 to 90 wt %, 60 to 85 wt %, 65 to 80 wt %, or 70 to 75 wt % on a dry basis.

In one aspect, the washing temperature can be room temperature, 45° C., 50° C., 55° C., 60° C., 65° C., 70° C., 75° C., 80° C., or 85° C. For example, the washing temperature can be in a range of room temperature to 85° C., room temperature to 80° C., room temperature to 75° C., room temperature to 70° C., room temperature to 65° C., room temperature to 60° C., room temperature to 55° C., room temperature to 50° C., room temperature to 45° C., 45 to 85° C., 45 to 80° C., 45 to 75° C., 45 to 70° C., 45 to 60° C., 50 to 85° C., 50 to 80° C., 50 to 75° C., 50 to 70° C., 50 to 65° C., 55 to 85° C., 55 to 80° C., 55 to 75° C., 55 to 70° C., 60 to 85° C., 60 to 80° C., 60 to 75° C., 65 to 85° C., 65 to 80° C., or 65 to 75° C.

Preferably, the washing temperature can be in a range of room temperature to 85° C., more preferably of 65 to 75° C.

In one aspect, a washing agent can be water (e.g., tap water or deionized water) or water with an acid added. The added acid component can decrease the initial pH during washing.

In an aspect, the pH of the washing agent can be 4, 4.15, 4.55, 4.85, 5, 5.15, 5.45 or 5.75. For example, the pH of the washing agent can be in a range of 4 to 5.75, 4 to 5.45, 4 to 5.15, 4 to 4.85, 4 to 4.55, 4.15 to 5.75, 4.15 to 5.45, 4.15 to 5.15, 4.15 to 4.85, 4.25 to 5.75, 4.25 to 5.45, 4.25 to 5.15, 4.25 to 4.85, 4.25 to 4.55, 4.55 to 5.75, 4.55 to 5.45, 4.55 to 5.15, 4.55 to 4.85, 4.75 to 5.25, 4.85 to 5.75, 4.85 to 5.45, 4.85 to 5.15, 5.15 to 5.75, 5.15 to 5.45, or 5.45 to 5.75.

In one aspect, salts can be added to water as a washing agent.

In one aspect, duration of the washing step can be 10 minutes, 15 minutes, 20 minutes, 25 minutes, or 30 minutes. For example, the duration can be in a range of 10 to 30 minutes, 10 to 25 minutes, 10 to 20 minutes, 15 to 30 minutes, or 15 to 25 minutes.

In one aspect, the washing step is a co-current washing or countercurrent washing. When a countercurrent washing scheme is used, a smaller total volume of washing agent would be used but the duration of the entire washing period would be the same.

In an aspect, the washing step can be performed for one time, at least one time, two times, at least twice, three times, or at least thrice. Preferably, one or more process parameters of the method can be the same or different in each washing step, where the process parameters may include, but may not be limited to, a ratio of the washing agent to the extruded vegetable protein material, pH of the washing agent, washing temperature, or duration of washing.

For example, a washing agent for a first washing step (initial washing agent) can be water with an acid added. The pH of the initial washing agent can be 4 to 5.75, preferably 4.25 to 5.25. Washing agent(s) for subsequent washing step(s) (subsequent washing agent(s)) can be water having the same or, preferably, different pH from the pH of the initial washing agent.

In one aspect, the washing agent to the extruded vegetable protein material in the washing step can be in a ratio of 4:1 to 40:1, from 4:1 to 35:1, from 4:1 to 30:1, from 4:1 to 25:1, from 4:1 to 20:1, from 4:1 to 15:1, 4:1 to 10:1, 4:1 to 7:1, 4:1 to 6:1, 4:1 to 5:1, 5:1 to 10:1, 5:1 to 9:1, 5:1 to 8:1, 5:1 to 7:1, 6:1 to 10:1, 6:1 to 8:1, or 6:1 to 5:1. In an aspect, the washing agent to the extruded vegetable protein material in the washing step can be in a ratio of 5:1, 6:1, or 8:1. For example, the extruded vegetable protein material can be washed using countercurrent extraction at a ratio of 5:1, 6:1, or 10:1. In one aspect, the ratio of the washing agent to the extruded vegetable protein material in each washing step can be the same or different.

Preferably, the washing step can be performed three times and the ratio of the washing agent to the extruded vegetable protein material in each washing step can be from 4:1 to 10:1, preferably from 5:1 to 10:1.

Preferably, the ratio of the washing agent to the extruded vegetable protein material is a weight ratio.

In one aspect, the method also includes a step of drying the treated vegetable protein product at a drying temperature of 75° C., 80° C., 85° C., 90° C., 95° C., 100° C., 105° C., 110° C., 115° C., or 120° C. For example, the treated vegetable protein product can be dried at a drying temperature in a range of 75 to 120° C., 80 to 115° C., 85 to 110° C., 90° C. to 120° C., 90° C. to 110° C., 95° C. to 120° C., 95° C. to 115° C., 95° C. to 105° C., 100° C. to 120° C., 100° C. to 115° C., 100° C. to 110° C., 105° C. to 120° C., 105° C. to 110° C., or 110° C. to 120° C. A skilled artesian would appreciate that the treated vegetable protein product can be dried under different drying methods with different drying parameters.

### Method of Washing Extruded Vegetable Protein Material

In one aspect, this disclosure also describes a method of washing an extruded vegetable protein material. The method comprises steps of: (a) washing the extruded vegetable protein material at a washing temperature of from room temperature to 85° C. with a washing agent in a ratio of, washing agent to extruded vegetable protein material, from 4:1 to 40:1 to obtain a washed material, and (b) drying the washed material at a drying temperature of 75° C. to 120° C. to obtain a treated vegetable protein product. The resulting treated vegetable protein product has one or more improved attributes compared to the extruded vegetable protein material.

Preferably, the one or more improved attributes may include, but may not be limited to, an increased protein content, a reduced metal ion content, or any combinations thereof.

Preferably, the treated vegetable protein product has a protein content in a range of from 55 to 90 wt % on a dry basis.

In one aspect, one or more process parameters of the method are the same or different in each washing step. Preferably, the one or more process parameters may include, but may not be limited to, a ratio of the washing agent to the extruded vegetable protein material, pH of the washing agent, washing temperature, or duration of washing.

Preferably, the present invention provides a method of increasing protein content in a treated vegetable protein product by washing an extruded vegetable protein material, wherein the treated vegetable protein product has an increased protein content compared to the extruded vegetable protein material; more preferably, the washing process is described in this disclosure, such as in paragraphs [0016] to [0038].

Preferably, the present invention provides a method of reducing metal ion content in a treated vegetable protein product by washing an extruded vegetable protein material, wherein the treated vegetable protein product has a reduced metal ion content compared to the extruded vegetable protein material; more preferably, the washing process is described in this disclosure, such as in paragraphs [0016] to [0038].

### Treated Vegetable Protein Product

Preferably, the treated vegetable protein product of the present invention, made by any method described in this disclosure, has one or more improved attributes as compared to an unwashed extruded vegetable protein material. Examples of an unwashed extruded vegetable protein material may include, but may not be limited to, an extruded vegetable protein starting material of the present invention (e.g., extruded soy concentrate, extruded pea protein, and extruded wheat protein) that has not been subjected to the washing process of the present invention as described in this disclosure.

Preferably, the one or more improved attributes may include, but may not be limited to: an increased protein content, a reduced metal ion content, or any combinations thereof.

Preferably, the treated vegetable protein product described in this disclosure has an increased protein content as compared to an unwashed extruded vegetable protein material. In one aspect, the treated vegetable protein product of the present invention may have a protein content in a range of 55 to 90 wt %, 60 to 85 wt %, 65 to 80 wt %, or 70 to 75 wt % on a dry basis.

Preferably, the treated vegetable protein product described in this disclosure has a reduced metal ion content as compared to an unwashed extruded vegetable protein material. In other words, the content of one or more metal ions in the treated vegetable protein product described in this disclosure is lower compared to an unwashed extruded vegetable protein material. Examples of metal ions may include, but may not be limited to, calcium ion, copper ion, iron ion, potassium ion, magnesium ion, sodium ion, or any combination thereof.

Preferably, the treated vegetable protein product described in this disclosure may have one or more ions content that is at least 10%, preferably at least 30%, more preferably at least 50%, lower than the one or more ions content of an unwashed extruded vegetable protein material. The one or more metal ions may include, but may not be limited to, calcium ion, copper ion, iron ion, potassium ion, magnesium ion, or sodium ion.

In one aspect, the treated vegetable protein product may have a phosphorus content that is at least 20%, preferably at least 50%, more preferably at least 75% lower than the phosphorus content of an unwashed extruded vegetable protein material.

Preferably, the treated vegetable protein product of the present invention is washed by the method as described in this disclosure. More preferably, the treated vegetable protein product of the present invention may have one or more of the following features: an increased protein content compared to an unwashed extruded vegetable protein material and a reduced metal ion content compared to an unwashed extruded vegetable protein material. More preferably, the treated vegetable protein product of the present invention may have an increased protein content and a reduced metal ion content as compared to an unwashed extruded vegetable protein material.

In one aspect, attributes other than the protein concentration and the metal ion content of the treated vegetable protein product produced or treated (e.g., washed) by any method described in this disclosure is improved as compared to the unwashed extruded vegetable protein material. Such attributes include, but are not limited to, flavor, taste, aroma, color, free amino acid concentration, metal ion concentration, carbohydrate concentration.

### EXAMPLES

The invention is further described in detail by reference to the following experimental examples. These examples are provided for purposes of illustration only and are not intended to be limiting unless otherwise specified. Thus, the invention should in no way be construed as being limited to the following examples, but rather should be construed to encompass any and all variations which become evident as a result of the teaching provided herein.

### Example 1

### Materials and Method

The following ingredients were used for this study: two lots of extruded soy flour (TSF) (Cargill Incorporated), three lots of extruded soy protein concentrate (TSC) (Cargill Incorporated), three lots of extruded pea protein (TPP) (Cargill Incorporated), and three lots of extrude wheat protein (TWP) (Cargill Incorporated) that contains vital wheat gluten (80 wt %), soy flour (17 wt %), and processing aids (3 wt %). Each lot was divided into washed and unwashed portions.

The unwashed portion was placed in a mylar bag and frozen.

The first wash began when 100 g TSF, 100 g TSC, 100 g TPP, and 100 g TWP were separately mixed with 500 g of water (pre-heated at 65° C.) that contained about 2.5 g of 25 wt % HCl. The resulting suspensions were gently mixed to promote hydration and the pH was adjusted to 5.0 (+0.1) with 25 wt % NaOH or 25 wt % HCl, as appropriate. The suspensions were then placed in a 65° C. water bath to maintain the temperature for 10 minutes. The liquid and solids were separated using a 100-micron screen with a fitted weight to promote drainage. After draining for 5 minutes, the washed solids were retrieved.

A second wash began when the washed solids were resuspended in fresh 500 g of water (pre-heated at 65° C.) without pH adjustment. The mixture was placed in a 65° C. water bath to maintain the temperature for 10 minutes. Water was drained out using the same screening method as in the first wash to retrieve the twice-washed solids.

A third wash began when the twice-washed solids were resuspended in another fresh 500 g of water (pre-heated at 65° C.) without pH adjustment. The mixture was placed in a 65° C. water bath to maintain the temperature for 10 minutes. Water was drained out using the same screening method as in the first and second washes and the obtained thrice-washed solids were spread on an aluminum sheet. The thrice-washed solids were partially dried at 90° C. and 0% relative humidity (RH) in a Unox Cheftop combi-oven for 30 minutes with stirring at the 10^{th} minute and the 20^{th} minute. The partially dried solids were then brought to the final moisture level (between 2.5 and 7%) using a fluid bed dryer (Sherwood Tornado Model 501) with temperature set at 75° C. for 15 minutes to obtain the washed TSF samples, washed TSC samples, washed TPP samples, and washed TWP samples. Air flow was adjusted between a setting of 50 and 75 to ensure fluidization of the bed. All the washed samples had a final moisture content between 2.5 and 7%.

### Protein Content Evaluation

Moisture was measured by oven drying. Protein was analyzed using an Elementary combustion analyzer using a 6.25 conversion factor for all samples. Results were shown in Table 1 below.

TABLE 1
Increase in protein concentration in washed samples.

| | Unwashed | Washed | |
|---|---|---|---|
| | samples | samples | p-value |
| TSF | 55.9 | 75.3 | <0.0001 |
| TSC | 74.3 | 80.5 | 0.018 |
| TPP | 80.8 | 83.5 | 0.432 |
| TWP | 74.8 | 84.2 | <0.0001 |

In general, the washing process increased protein content in the washed samples.

TSF raw materials had an average protein content of 55.9 wt %. After washing, the protein content of the washed samples was 75.3 wt. %. Thus, the washing process significantly increased protein content in the washed TSF samples.

TSC raw materials had an average protein content of 74.3 wt %. After washing, the protein content of the washed samples was 80.5 wt. %. Thus, the washing process significantly increased protein content in the washed TSC samples.

The three lots of TPP raw materials had different initial protein contents of 82.75 wt %, 83.26 wt %, and 76.37 wt % on a dry basis. After washing, the protein contents of the three resulting extruded pea protein products were 86.17 wt %, 85.26 wt %, and 79.14 wt % on a dry basis, respectively. Thus, the protein content increased by 3.41 wt %, 2.01 wt %, and 2.77 wt %, respectively. The average change was 2.73 wt % with a 95% confidence interval of 0.80. Therefore, the washing process significantly increased protein content in the washed TPP samples.

TWP raw materials had an average protein content of 74.8 wt %. After washing, the protein content of the washed samples was 84.2 wt. %. Thus, the washing process significantly increased protein content in the washed TWP samples.

### Example 2

### Materials and Method

The extruded vegetable proteins (TVP) used in this study included three lots of extruded soy flour (TSF) (Cargill Incorporated), three lots of extruded soy protein concentrate (TSC) (Cargill Incorporated), three lots of extruded pea protein (TPP) (Cargill Incorporated), and three lots of extrude wheat protein (TWP) (Cargill Incorporated) that contains vital wheat gluten (80 wt %), soy flour (17 wt %), and processing aids (3 wt %).

The first wash began when 1 part of each of the four extruded vegetable proteins (TVP) was individually mixed with 10 parts of water (pre-heated at 65° C.). The pH of the resulting suspensions was adjusted to 5 and the suspensions were then placed in a 65° C. water bath to maintain the temperature for 10 minutes. The water was removed by filtration through an aluminum screen for 5 minutes (with no drainage apparently visible after 3 minutes). After draining for 5 minutes, the washed solids were retrieved.

A second wash began when the washed solids were resuspended in fresh water (pre-heated at 65° C.) at a mass ratio of, washed solids to water, 1:7.5. The mixture was placed in a 65° C. water bath to maintain the temperature for 10 minutes. Water was drained out using the same screening method as in the first wash to retrieve the twice-washed solids.

A third wash began when the twice-washed solids were resuspended in fresh water (pre-heated at 65° C.) at a mass ratio of, washed solids to water, 1:7.5. The mixture was placed in a 65° C. water bath to maintain the temperature for 10 minutes. Water was drained out using the same screening method as in the first and second washes and the obtained thrice-washed solids were dried at 115° C. overnight under vacuum.

Samples of the starting materials (i.e., unwashed TSF, unwashed TSC, unwashed TPP, and unwashed TWP) and the corresponding washed samples (i.e., washed TSF, washed TSC, washed TPP, and washed TWP) were analyzed by inductively coupled plasma (ICP-MS). All values were corrected to a dry weight basis before statistical analysis.

### Results and Discussion

As shown in Table 2, unwashed TSF had an extremely low Na concentration to begin with and increased slightly through treatment. Metal ions such as Cu, K, and Mg were at lower concentrations after washing. Phosphorus content was also reduced after washing.

TABLE 2
Reduction in metal ions and phosphorus
content in washed TSF samples.

| | Metal Ion | | | |
|---|---|---|---|---|
| | Concentration (ppm) | | Average | Average |
| Metal Ions | Unwashed | Washed | change (ppm) | change % |
| Ca | 3,427 | 3,477 | 50 | 1% |
| Cu | 16 | 14 | −1.80 | −13% |
| Fe | 81 | 93 | 11.19 | 15% |
| K | 25,225 | 6,196 | −19,028 | −75% |
| Mg | 3,142 | 1,723 | −1,419.4 | −45% |
| Na | 14 | 22 | 8.7 | 57% |
| P | 8,689 | 6,504 | −2,185 | −25% |

As shown in Table 3, potassium ions showed a significant difference in mean concentrations between washed and unwashed TSC samples; the decline in Na concentration was about 60%. After computation of the change, both potassium and sodium ions showed quite large effects of washing. Ions such as Ca, Cu, Fe, K, Mg, and Na were at lower concentrations after washing. Though the average concentration of Cu appears unchanged, there was a considerable difference in the Cu concentrations in the unwashed samples. Paired comparisons showed that washing decreased the Cu concentration slightly. Phosphorus content was also reduced after washing.

TABLE 3
Reduction in metal ions and phosphorus
content in washed TSC samples.

| | Ion Concentration | | | |
|---|---|---|---|---|
| | (ppm) | | Average | Average |
| | Unwashed | Washed | change (ppm) | change % |
| Ca | 3,794 | 3,596 | −198.2 | −5% |
| Cu | 10 | 9 | −0.73 | −7% |
| Fe | 117 | 108 | −9.233 | −8% |
| K | 21,534 | 7,084 | −14,450 | −67% |
| Mg | 3,181 | 1,848 | −13,334 | −42% |
| Na | 110 | 47 | −62.3 | −57% |
| P | 8,863 | 5,481 | −3,382 | −38% |

As shown in Table 4, potassium ions showed a significant difference in mean concentrations between washed and unwashed TPP samples; the decline in Na concentration was about 70%. After computation of the change, both potassium and sodium ions showed quite large effects of washing. Ions such as Cu, K, Mg, and Na were at lower concentrations after washing. Though the average concentration of Cu appears unchanged, there was a considerable difference in the Cu concentrations in the unwashed samples. Paired comparisons showed that washing decreased the Cu concentration slightly. Phosphorus content was also reduced after washing.

TABLE 4
Reduction in metal ions and phosphorus
content in washed TPP samples.

| | Ion Concentration | | | |
|---|---|---|---|---|
| | (ppm) | | Average | Average |
| | Unwashed | Washed | change (ppm) | change % |
| Ca | 7,090 | 7,931 | 463.7 | 7% |
| Cu | 6 | 6 | −0.509 | −8% |
| Fe | 163 | 187 | 15.18 | 9% |
| K | 3,099 | 1,204 | −2,066 | −67% |
| Mg | 2,054 | 2,092 | −74.1 | −4% |
| Na | 5,674 | 1,943 | −4,030 | −71% |
| P | 13,478 | 13,825 | −383 | −3% |

As shown in Table 5, potassium ions showed a significant difference in mean concentrations between washed and unwashed textured wheat protein samples; the decline in Na concentration was above 95%. After computation of the change, both potassium and sodium ions showed quite large effects of washing. Ions such as Ca, Fe, K, Mg, and Na were at lower concentrations after washing. Phosphorus content was also reduced after washing.

TABLE 5
Reduction in metal ions and phosphorus
content in washed TWP samples.

| | Ion Concentration | | | |
|---|---|---|---|---|
| | (ppm) | | Average | Average |
| | Unwashed | Washed | change (ppm) | change % |
| Ca | 972 | 826 | −218 | −22% |
| Cu | 7 | 9 | 1.703 | 24% |
| Fe | 55 | 51 | −8.1 | −15% |
| K | 5,810 | 776 | −5,463 | −94% |
| Mg | 949 | 756 | −263.6 | −28% |
| Na | 11,201 | 1,228 | −10,803 | −96% |
| P | 9,742 | 3,150 | −,7314 | −75% |

What is claimed is:

1. A method of making a treated vegetable protein product, comprising the steps of:
a. providing an extruded vegetable protein material; and
b. performing a washing step on the extruded vegetable protein material to obtain the treated vegetable protein product, wherein the washing step comprises washing the extruded vegetable protein material at a washing temperature of room temperature to 85° C. with a washing agent;
wherein the treated vegetable protein product has one or more improved attributes compared to the extruded vegetable protein material; and the washing agent to the extruded vegetable protein material in the washing step is in a ratio of 4:1 to 40:1; wherein the one or more improved attributes are selected from the group consisting of an increased protein content, a reduced metal ion content, and any combinations thereof.

2. (canceled)

3. The method of claim 1, wherein the treated vegetable protein product has a protein content in a range of from 55 to 90 wt % on a dry basis.

4. The method of claim 1 further comprising a step of:
c. drying the treated vegetable protein product at a drying temperature of 75° C. to 120° C.

5. The method of claim 1, wherein one or more process parameters of the method are the same or different in each washing step, and the one or more process parameters are selected from the group consisting of a ratio of the washing agent to the extruded vegetable protein material, pH of the washing agent, washing temperature, and duration of washing.

6. The method of claim 1, wherein the extruded vegetable protein material is selected from the group consisting of extruded soy concentrate, extruded pea protein, and extruded wheat protein.

7. The method of claim 1, wherein the extruded vegetable protein material is not extruded soy flour.

8. A method of washing an extruded vegetable protein material, comprising the steps of:
a. washing the extruded vegetable protein material at a washing temperature of from room temperature to 85° C. with a washing agent in a ratio of, washing agent to extruded vegetable protein material, from 4:1 to 40:1 to obtain a washed material; and
b. drying the washed material at a drying temperature of from 75° C. to 120° C. to obtain a treated vegetable protein product;
wherein the treated vegetable protein product has one or more improved attributes compared to the extruded vegetable protein material; wherein the one or more improved attributes are selected from the group consisting of an increased protein content, a reduced metal ion content, and any combinations thereof.

9. (canceled)

10. The method of claim 8, wherein the treated vegetable protein product has a protein content in a range of from 55 to 90 wt % on a dry basis

11. The method of claim 8, wherein one or more process parameters of the method are the same or different in each washing step, and the one or more process parameters are selected from the group consisting of a ratio of the washing agent to the extruded vegetable protein material, pH of the washing agent, washing temperature, and duration of washing.

12. The method of claim 8, wherein the extruded vegetable protein material is selected from the group consisting of extruded soy concentrate, extruded pea protein, and extruded wheat protein.

13. The method of claim 8, wherein the extruded vegetable protein material is not extruded soy flour.

14. (canceled)

15. A treated vegetable protein product having one or more improved attributes compared to an unwashed extruded vegetable protein material, wherein the one or more improved attributes are selected from the group consisting of an increased protein content, a reduced metal ion content, and any combinations thereof.

16. The treated vegetable protein product of claim 15 having an increased protein content compared to an unwashed extruded vegetable protein material.

17. The treated vegetable protein product of claim 15 has a protein content in a range of from 55 to 90 wt % on a dry basis.

18. (canceled)

19. The treated vegetable protein product of claim 15, wherein the metal ion is selected from the group consisting of calcium ion, copper ion, iron ion, potassium ion, magnesium ion, and sodium ion.

20. The treated vegetable protein product of claim 15, having one or more metal ions content at least 10%, preferably at least 30%, more preferably at least 50%, lower than the one or more ions content of an unwashed extruded vegetable protein material, wherein the one or more ions are selected from calcium ion, copper ion, iron ion, potassium ion, magnesium ion, and sodium ion.

21. The treated vegetable protein product of claim 15, wherein the treated vegetable protein product is made from an extruded soy protein material, wherein the extruded vegetable protein material is selected from the group consisting of extruded soy concentrate, extruded pea protein, and extruded wheat protein.

22. The treated vegetable protein product of claim 15, wherein the extruded vegetable protein material is not extruded soy flour.

23. The treated vegetable protein product of claim 15, which is made by the method of claim 1.
